(19) United States
(12) Patent Application Publication
(10) Pub. No.: US 2025/0077139 A1
(43) Pub. Date: Mar. 6, 2025

(54) IMAGE PROCESSING APPARATUS, IMAGE PROCESSING APPARATUS CONTROL METHOD, AND NON-TRANSITORY COMPUTER READABLE STORAGE MEDIUM

(71) Applicant: CANON KABUSHIKI KAISHA, Tokyo (JP)

(72) Inventor: RURIKO MIKAMI, Kanagawa (JP)

(21) Appl. No.: 18/811,537

(22) Filed: Aug. 21, 2024

(30) Foreign Application Priority Data
Aug. 29, 2023 (JP) 2023-138697

(51) Int. Cl. G06F 3/12; G06K 19/06

(52) U.S. Cl. CPC G06F 3/1222; G06F 3/1238; G06K 19/06037

(57) ABSTRACT

An image processing apparatus control method includes receiving, from an information processing apparatus, a request for a web page provided by an image processing apparatus; and transmitting the web page to the information processing apparatus in accordance with receiving the request in the receiving. In response to the request being received in the receiving, a web page including code information to the information processing apparatus is transmitted in the transmitting in accordance with authentication information satisfying a predetermined condition, the authentication information being used for authentication for displaying a web page including information of the image processing apparatus on the information processing apparatus, the code information being to be captured to display, on a mobile terminal, operation required to set the authentication information by using an operation unit of the image processing apparatus.

### BACKGROUND

### Field

The present disclosure relates to an image processing apparatus, an image processing apparatus control method, and a non-transitory computer readable storage medium.

### Description of the Related Art

To date, there is remote user interface (RUI) technology by which an information processing apparatus displays information of an image processing apparatus with a web browser.

For the information processing apparatus to acquire the information of the image processing apparatus from the image processing apparatus, authentication information is required to be input.

If the authentication information used for authentication is not set correctly in the image processing apparatus, the information of the image processing apparatus or the authentication information set in image processing apparatus may be performed by an unintended user.

Technology exists such that if the authentication information used for the authentication is not set correctly, there is a restriction on both acquiring the information of the image processing apparatus from the information processing apparatus and settings of the image processing apparatus along with display of a brief error message on the information processing apparatus.

Japanese Patent Laid-Open No. 2007-41840 describes technology for displaying a two-dimensional code on the panel of a printer when an error occurs.

To resolve the error, a user needs to correctly set the authentication information in the image processing apparatus by operating an operation unit of the image processing apparatus.

If a resolving method for resolving an error is displayed on the information processing apparatus as in Japanese Patent Laid-Open No. 2007-41840, but if the image processing apparatus is remote from the information processing apparatus, it is not possible for the user to operate the operation unit of the image processing apparatus while looking at a measure against the error.

The method in Japanese Patent Laid-Open No. 2007-41840 simply provides displaying the two-dimensional code on the operation unit of the image processing apparatus, and thus it is not possible for the user to notice the display while operating the information processing apparatus.

### SUMMARY

The present disclosure provides an image processing apparatus that includes an operation unit configured to set authentication information used to operate the image processing apparatus; a reception unit configured to receive, from an information processing apparatus, a request for a web page provided by the image processing apparatus; and a transmission unit configured to transmit the web page to the information processing apparatus. In response to receiving the request, transmitting a web page including code information to the information processing apparatus in accordance with authentication information that satisfies a predetermined condition and that is used for authentication for displaying a web page including information of the image processing apparatus on the information processing apparatus. The displayed code information is displayed on a mobile terminal to provide operations required to set the authentication information by the operation unit of the image processing apparatus.

Further features of the present disclosure will become apparent from the following description of exemplary embodiments (with reference to the attached drawings).

### BRIEF DESCRIPTION OF THE DRAWINGS

FIG. 1 is a view illustrating the configuration of an online manual guidance system.

FIG. 2 is a view illustrating the hardware configuration of a smartphone, a personal computer (PC), and a printer.

FIG. 3 is a table illustrating a list of error information regarding the printer.

FIG. 4 is a view illustrating a RUI login screen of the printer.

FIG. 5 is a view illustrating a RUI login error screen of the printer.

FIG. 6 is a flowchart illustrating RUI login control processing.

FIG. 7 is a flowchart illustrating processing by the online manual guidance system.

FIG. 8 is a view illustrating a RUI login error screen for smartphone.

FIG. 9 is a flowchart illustrating RUI login control processing.

FIG. 10 is a table illustrating a list of error information regarding the printer.

FIG. 11 is a view illustrating an error screen not requiring printer operation to resolve an error.

FIG. 12 is a flowchart illustrating error control processing.

FIG. 13 is a view illustrating a screen for setting the password and the ID for the RUI.

### DESCRIPTION OF THE EMBODIMENTS

Hereinafter, exemplary embodiments of the present disclosure will be described in detail with reference to the drawings. The following exemplary embodiments do not restrict the disclosure according to the scope of the claims, and not all the combinations of features described in the exemplary embodiments are necessarily essential to the solving means of the disclosure.

### Exemplary Embodiment 1

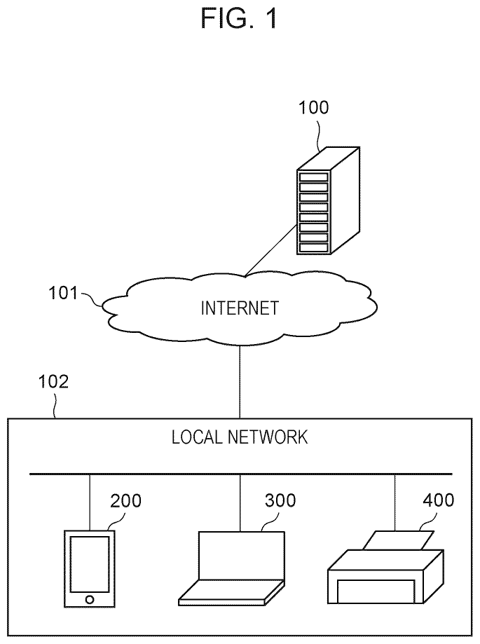

FIG. 1 is a view illustrating the configuration of a system for guiding to an online manual according to Exemplary Embodiment 1 of the present disclosure.

The system includes an online user manual server 100, the Internet 101, and a local network 102.

The local network 102 includes a smartphone 200 serving as an example of a mobile terminal, a PC 300 serving as an example of an information processing apparatus, and a printer 400 serving as an example of an image processing apparatus.

The printer 400 has a web server function. A user accesses the web server function of the printer 400 with a RUI using a web browser by operating the smartphone 200 or the PC 300. The user then operates a web page provided by the web server function and thereby may change the settings of the printer 400 and refer to the status of the printer 400.

The smartphone 200 and the PC 300 access the web server function of the printer 400 via the local network 102. The local network 102 may be a wired network or a wireless network.

The online user manual server 100 includes a user manual of the printer 400, and the user may refer to the user manual by operating the web browser of the smartphone 200 or the PC 300.

The smartphone 200 and the PC 300 are allowed to connect to the online user manual server 100 via the Internet 101.

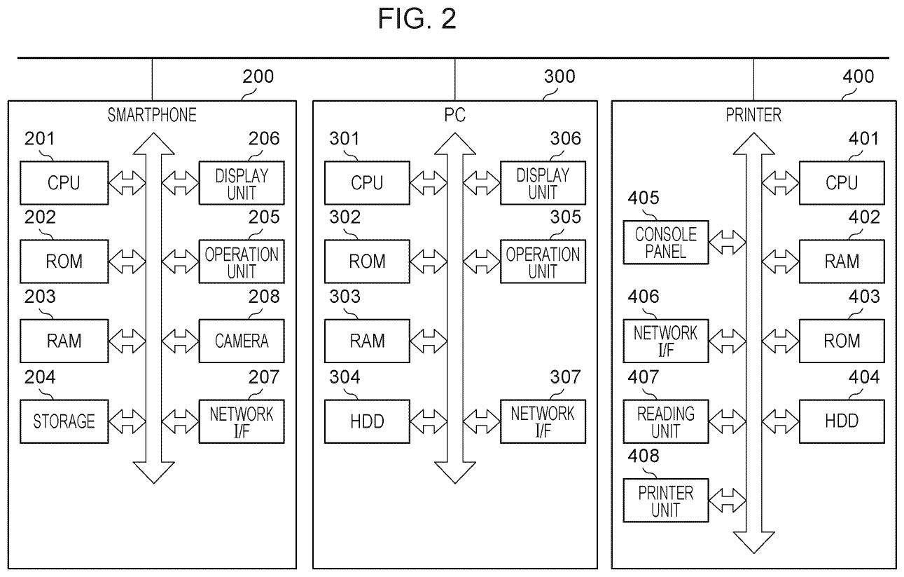

FIG. 2 is a view illustrating the hardware configuration of the smartphone 200, the PC 300, and the printer 400 according to Exemplary Embodiment 1.

The smartphone 200 has a CPU 201, a ROM 202, a RAM 203, a HDD 204, a display unit 206, an operation unit 205, a camera 208, and a network I/F 207. CPU, ROM, RAM, HDD, and I/F respectively stand for central processing unit, read only memory, random access memory, hard disk drive, and interface.

The CPU 201 is a system control unit, loads various programs stored in the ROM 202 or the HDD 204 into the RAM 203, and performs overall control of the smartphone 200.

The ROM 202 is a nonvolatile memory and stores the various programs.

The RAM 203 is a volatile memory and is used as a work memory for the CPU 201.

A storage 204 stores the operating system (OS) as basic software, a web browser, and software modules. The storage 204 is, for example, an embedded multi media card (eMMC).

The operation unit 205 is a device for the user to perform an input operation and forms a touch panel sheet or hardware keys.

The display unit 206 is a display for displaying a screen.

The network I/F 207 is an interface for connecting the smartphone 200 to the local network 102 and the Internet 101.

The camera 208 is a device for reading a QR code (registered trademark) or the like serving as an example of code information. Quick response code is abbreviated as QR code. The code information is not limited to the QR code, and any other code convertible to certain information is usable.

The PC 300 has a CPU 301, a ROM 302, a RAM 303, a HDD 304, a display unit 306, an operation unit 305, and a network I/F 307.

The CPU 301 is a system control unit, loads various programs stored in the ROM 302 or the HDD 304 into the RAM 303, and performs overall control of the PC 300.

The ROM 302 is a nonvolatile memory and stores the various programs.

The RAM 303 is a volatile memory and is used as a work memory for the CPU 301.

The HDD 304 stores the OS serving as basic software, a web browser, and software modules.

The operation unit 305 is a device for the user to perform an input operation and is a touch panel sheet or a hardware keyboard.

The display unit 306 is a display for displaying a screen.

The network I/F 307 is an interface for connecting the PC 300 to the local network 102 and the Internet 101.

The printer 400 has a CPU 401, a RAM 402, a ROM 403, a HDD 404, a console panel 405, a network I/F 406, a reading unit 407, and a printer unit 408.

The printer 400 does not have to have the reading unit 407.

The CPU 401 of the printer 400 loads various programs stored in the ROM 403 or the HDD 404 into the RAM 402 and performs overall control of the printer 400.

The RAM 402 is a volatile memory and is used as a work memory for the CPU 401.

The ROM 403 is a nonvolatile memory and stores the various programs. The ROM 403 also stores programs for the RUI or the like and the initial values of the ID and the password for the RUI.

The HDD 404 is a nonvolatile storage and stores the ID, the password, and the like for the RUI that are set with the console panel 405.

The console panel 405 has a touch panel and hardware keys, the touch panel having a touch panel sheet attached to a display unit. The console panel 405 receives operation from the user via the touch panel sheet or the hardware keys and displays information on the display unit.

The network I/F 406 is an interface for connecting to the local network 102 and the Internet 101.

The reading unit 407 reads a document and generates image data of the read document.

Based on the image data, the printer unit 408 controls print operation performed on the sheet. The printer unit 408 may be an inkjet printer unit or an electrophotographic printer unit.

The printer 400 as described above executes a copy job and a print job. The copy job is a job for printing by the printer unit 408 based on image data generated by reading a document image by the reading unit 407. The user may cause the printer 400 to execute the copy job by performing a copying setting operation with the console panel 405 and giving an execution instruction with the console panel 405. The print job is a job for printing by the printer unit 408 based on printing data received by the printer 400. The user operates the operation unit 305 of the PC 300 and thereby calls a printer driver in a state where image data being edited by the application of the PC 300. The user performs a printing setting operation with the printer driver and gives a printing instruction, and thereby the print job is transmitted from the PC 300 to the printer 400. The printer 400 having received the print job performs printing of the image data based on the printing settings.

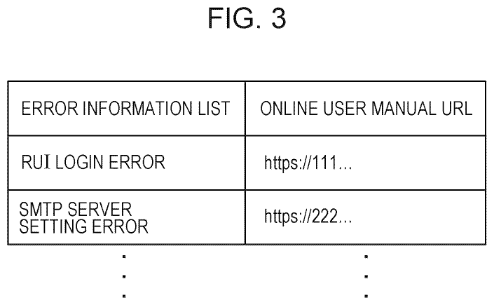

FIG. 3 is a table illustrating a list of error information regarding the printer 400 according to Exemplary Embodiment 1.

The printer 400 manages the URLs of online user manuals describing all of pieces of information regarding possible errors and measures that a user may take to correct any errors in the ROM 403 in relation to the pieces of error information. The URLs of the online user manuals represent the user manuals included in the online user manual server 100. The error information list (FIG. 3) is stored in the ROM 403.

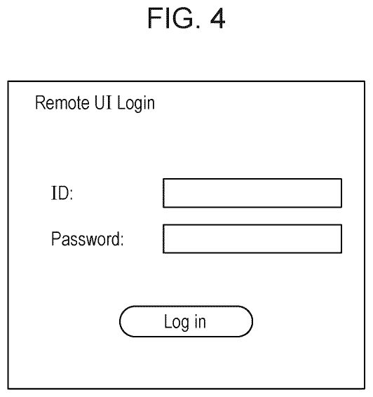

FIG. 4 is a view illustrating a RUI login screen of the printer 400 according to Exemplary Embodiment 1. When the user accesses the RUI of the printer 400 by using the smartphone 200 or the web browser of the PC 300, a RUI login screen (FIG. 4) is displayed on the display unit 206 or the display unit 306.

The RUI login screen (FIG. 4) has areas for inputting the ID and the password for logging in the RUI and the Log in button that are arranged thereon.

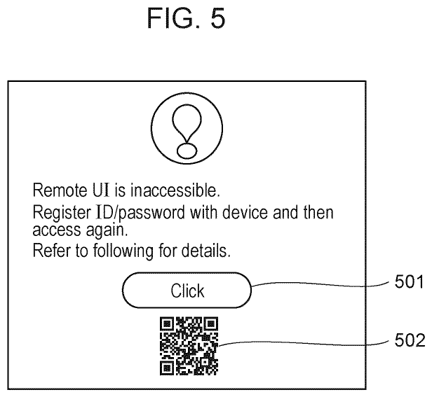

FIG. 5 is view illustrating a RUI login error screen of the printer 400 according to Exemplary Embodiment 1.

The RUI login error screen (FIG. 5) has a Click button 501 and a QR code 502 that are arranged thereon. In the Click button 501 and the QR code 502, an online user manual URL related to a RUI login error in the error information list (FIG. 3) is embedded.

When the user accesses the RUI of the printer 400 by using the smartphone 200 or the web browser of the PC 300, the RUI login error screen (FIG. 5) is displayed on the display unit 206 or the display unit 306.

In response to the user pressing the Click button 501, the user manual describing a way to correct the RUI login error is displayed on the display unit 206 or the display unit 306. In addition, in response to the user capturing the QR code 502 with the camera 208 of the smartphone 200, the user manual describing the measure against the RUI login error is displayed on the display unit 206.

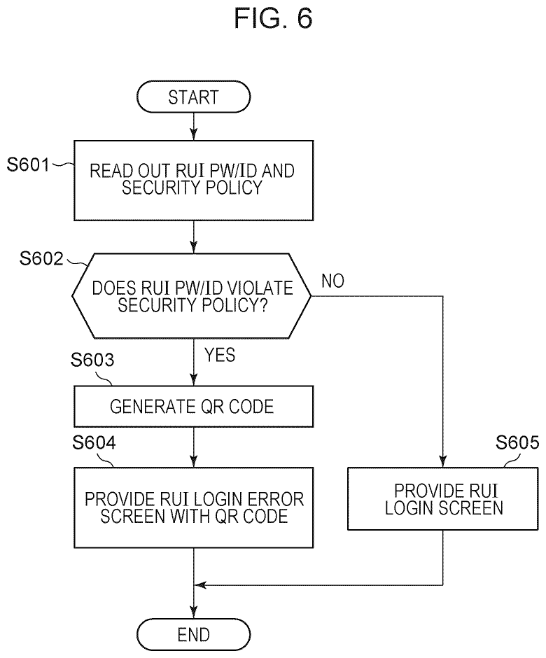

FIG. 6 is a flowchart illustrating RUI login control processing according to Exemplary Embodiment 1.

Steps in the flowchart in FIG. 6 are implemented in such a manner that the CPU 401 loads a program stored in the ROM 403 into the RAM 402 and runs the program.

The flowchart in FIG. 6 is started when the printer 400 detects an access to the RUI.

In S601, the CPU 401 reads out a password (PW) and an identifier (ID) set in the RUI function from the HDD 404. The PW and the ID are the information to be compared with the PW and the ID that are input by the user. The CPU 401 reads out a security policy for the RUI PW and ID from the ROM 403. The security policy represents, for example, change of the RUI PW and ID before the elapse of a predetermined period since the previous change or nonconformity of the RUI PW and ID with the initial values.

In S602, the CPU 401 determines whether the PW and the ID set in the RUI function conform to the security policy. The following are examples of nonconformity to the security policy: the RUI PW and ID have not been changed for the predetermined period since the previous change; the RUI PW and ID are identical to the initial values; or a PW or an ID is not set (the PW or the ID has a null value). If the CPU 401 determines that the PW and the ID violate the security policy, the CPU 401 proceeds the processing to S603. In contrast, if the CPU 401 determines that the PW and the ID conform to the security policy, the CPU 401 proceeds the processing to S605.

If the CPU 401 proceeds the processing to S605, the CPU 401 provides the accessing PC 300 with information for displaying the RUI login screen illustrated in FIG. 4 by using the network I/F 406 and terminates the flow. The CPU 301 of the PC 300 causes the RUI login screen illustrated in FIG. 4 to be displayed on the display unit 306 based on the received information.

In contrast, if the CPU 401 continues the processing from S602 to S603 (if a predetermined condition is satisfied), the CPU 401 reads out the error information list illustrated in FIG. 3 from the ROM 403 in S603. The CPU 401 acquires the URL of the online user manual (http://111 . . . ) related to the RUI login error. The CPU 401 then generates a QR code based on the acquired URL. QR codes generated in advance may be stored in the ROM 403, and the CPU 401 may read out one of the QR codes.

In S604, the CPU 401 provides the accessing PC 300 with the information for displaying the RUI login error screen illustrated in FIG. 5 by using the network I/F 406 and terminates the flow.

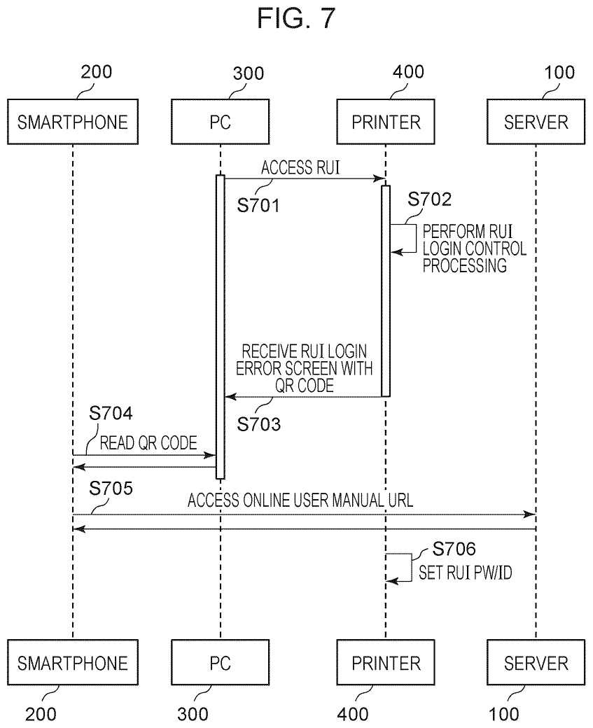

FIG. 7 is a sequence diagram illustrating the processing in the online manual guidance system according to the present disclosure. The sequence illustrated in this sequence diagram is started when the user accesses the URL for the RUI by using the web browser of the PC 300.

In S701, the CPU 301 of the PC 300 accesses the RUI of the printer 400 with a network I/F 307.

In S702, the CPU 401 of the printer 400 performs the RUI login control processing illustrated in FIG. 6. A case where the CPU 401 proceeds the processing to S603 in FIG. 6 will be described.

In S703, the CPU 301 of the PC 300 receives the information for displaying the RUI login error screen with QR code illustrated in FIG. 5. The CPU 301 of the PC 300 then causes a RUI login error screen with QR code to be displayed on the display unit 306.

In S704, the CPU 201 of the smartphone 200 reads, with the camera 208, the QR code on the RUI login error screen in FIG. 5 displayed on the display unit 306 of the PC 300. The CPU 201 then analyzes the QR code and acquires the URL of the online user manual.

In S705, the CPU 201 accesses the acquired URL of the online user manual by using the network I/F 207 and transmits a request for the online user manual to the online user manual server 100. The CPU 201 receives the online user manual transmitted from the online user manual server 100 and causes the received online user manual to be displayed on the display unit 206.

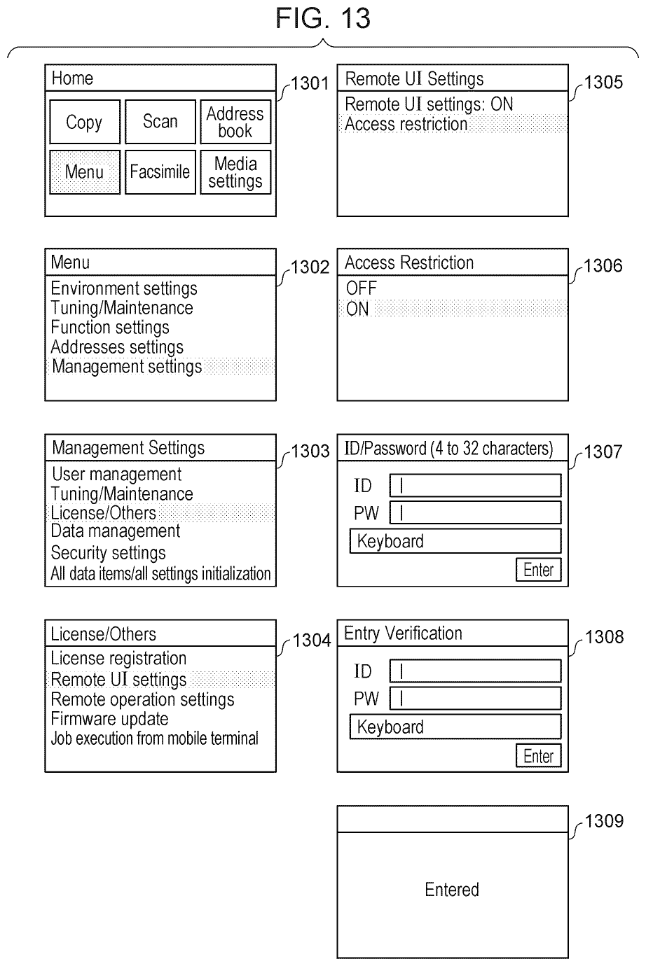

In S706, the user changes the RUI PW and ID with the console panel 405. The CPU 401 of the printer 400 stores, in the HDD 404, the RUI PW and ID changed with the console panel 405. The details thereof are described with reference to FIG. 13.

FIG. 13 is a screen flow chart for setting the password and the ID for the RUI according to the present disclosure. The screen illustrated in FIG. 13 is displayed on the console panel 405 by the CPU 401.

A screen 1301 is a home screen displayed on the console panel 405 when the power on button of the printer 400 is pressed. In response to the detection of the pressing of the Menu button, a screen 1302 is displayed.

The screen 1302 is a menu screen. In response to the detection of the pressing of Management Settings, a screen 1303 is displayed.

The screen 1303 is a management settings screen. In response to the detection of the pressing of License/Others, a screen 1304 is displayed.

The screen 1304 is a screen for licenses and others. In response to the detection of the pressing of Remote UI Settings, a screen 1305 is displayed.

The screen 1305 is a screen for the remote UI settings. In response to the detection of the pressing of Access Restriction, a screen 1306 is displayed.

The screen 1306 is a screen for the access restriction. In response to the detection of the pressing of ON, a screen 1307 is displayed.

The screen 1307 is a screen for inputting an ID and a PW. An ID input field, a PW input field, and software keyboard are displayed on the input screen. A plurality of keys for inputting figures and alphabets are displayed on the keyboard. In response to the selection of the ID input field and the detection of the pressing of keys, the CPU 401 stores, in the RAM 402, the ID input in the ID input field. In response to the selection of the PW input field and the detection of the pressing of keys, the CPU 401 stores, in the RAM 402, the PW input in the PW input field. Dummy characters are displayed in the ID input field and the PW input field. In response to the detection of the pressing of the Enter button, the CPU 401 determines whether the ID and the PW stored in the RAM 402 conform to a predetermined rule. If the ID and the PW do not conform to the rule, a message to that effect is displayed, and the screen 1307 is displayed again. If the ID and the PW conform to the rule, a screen 1308 is displayed.

The screen 1308 is a screen for inputting and verifying the ID and the password. An ID input field, a PW input field, and a software keyboard are displayed on the input screen. A plurality of keys for inputting figures and alphabets are displayed on the keyboard. In response to the selection of the ID input field and the detection of the pressing of keys, the CPU 401 stores, in the RAM 402, the ID input in the ID input field. In response to the selection of the PW input field and the detection of the pressing of keys, the CPU 401 stores, in the RAM 402, the PW input in the PW input field. Dummy characters are displayed in the ID input field and the PW input field. In response to the detection of the pressing of the Enter button, the CPU 401 determines whether the ID and the PW that are input on the screen 1308 match the ID and the PW that are input on the screen 1307. In the case of matching, a screen 1309 is displayed. In the case of non-matching, a message to that effect is displayed, and the screen 1308 is displayed again.

The screen 1309 is a screen for indicating the completion of the ID/PW setting. The CPU 401 causes the screen 1309 to be displayed on the console panel 405 for two seconds and causes the screen 1302 to be displayed on the console panel 405.

According to this exemplary embodiment as described above, if authentication information used for authentication for displaying, on the PC, a web page including information of a printer is not correctly set in the printer, the authentication information may be set easily.

Specifically, displaying, on the PC, the QR code for acquiring the online user manual enables guidance to the online user manual. Even if the PC and the printer are remote from each other, the user may thereby resolve an error by operating the printer while looking at the user manual describing the measure against the error by using the smartphone.

### Exemplary Embodiment 2

In Exemplary Embodiment 1, the same configuration is used for both of the cases of displaying the RUI login error screen in FIG. 5 on the PC and the smartphone. For this exemplary embodiment, an example where different respective RUI login error screens are provided for the smartphone and the PC is described. Detailed description of parts common to Exemplary Embodiment 1 such as the system configuration is omitted.

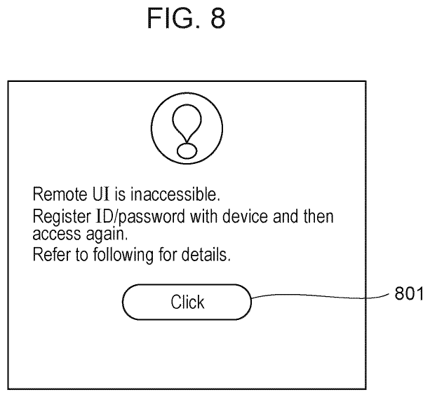

FIG. 8 is a view illustrating a RUI login error screen for smartphone in this exemplary embodiment.

The RUI login error screen for smartphone has a Click button 801 thereon. The Click button 801 has a link to the URL for displaying a user manual that describes a measure against a RUI login error and that is stored in the online user manual server 100.

When the user accesses the RUI of the printer 400 by using the web browser of the smartphone 200, the RUI login error screen illustrated in FIG. 8 is displayed on the display unit 206. In response to the user pressing the Click button 801, the user manual describing the measure against the RUI login error is displayed on the display unit 206 of the smartphone 200. The user moves to the printer 400 with the smartphone 200 and resolves the error.

As described above, since the device displaying the error screen in FIG. 8 is assumed to be portable to the printer, a QR code is not disposed on the error screen in FIG. 8, unlike the RUI login error screen in FIG. 5.

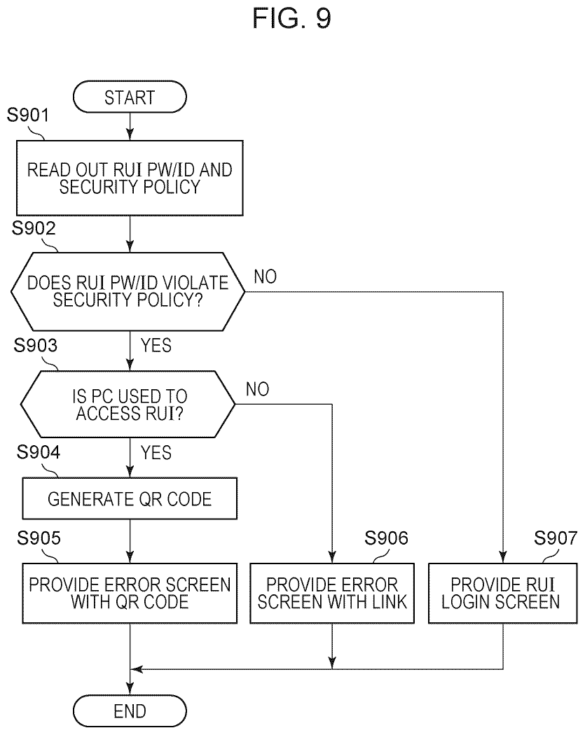

FIG. 9 is a flowchart illustrating RUI login control processing according to the present disclosure. The flowchart is started when the CPU 401 detects access to the RUI.

Steps in the flowchart in FIG. 9 are implemented in such a manner that the CPU 401 loads a program stored in the ROM 403 into the RAM 402 and executes the program.

The description of S901 and S902 is omitted because of the same steps in FIG. 6.

In S903, the CPU 401 acquires the screen size of a device having accessed the RUI function. The screen size means the size of the display unit 206 of the smartphone 200 and the size of the display unit 306 of the PC 300. Each screen size has been defined with a media query and a media type in cascading style sheet (CSS) included in information transmitted from the PC and may be acquired in such a manner that the CPU 401 refers to the information. If the acquired screen size is larger than or equal to a threshold (larger than or equal to a predetermined size), the CPU 401 determines that the device having accessed the RUI function is the PC 300 and proceeds the processing to S904. In contrast, if the acquired screen size is smaller than the threshold (smaller than the predetermined size), the CPU 401 determines that the device having accessed the RUI function is the smartphone 200 and proceeds the processing to S906. The threshold is stored in the ROM 403 or the HDD 404 and is referred to by the CPU 401.

The description of S904, S905, and S907 is omitted because of the same steps as S603, S604, and S605 in FIG. 6.

In S906, the CPU 401 provides the accessing device with the smartphone RUI login error screen illustrated in FIG. 8 by using the network I/F 406 and terminates the flow.

In this exemplary embodiment as described above, an error screen without a QR code is provided to a smartphone. The user who accesses the RUI with the smartphone may thereby be guided to a manual without capturing the QR code. If a printer is remote from a PC, the user moves to the printer with the smartphone and may resolve the error.

### Exemplary Embodiment 3

In Exemplary Embodiment 2, the configuration in which the different respective error screens for smartphone and PC are provided is used. In this exemplary embodiment, a configuration in which an error screen different depending on whether printer operation is required to resolve an error is used. Detailed description of parts common to Exemplary Embodiment 1 such as the system configuration is omitted.

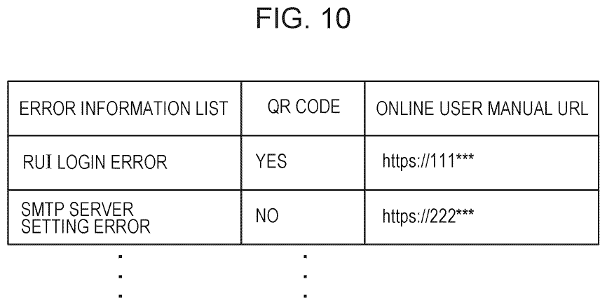

FIG. 10 is a table illustrating a list of types of error information of the printer 400 according to the present disclosure. In the table, information regarding whether to provide a QR code is added to the error information list illustrated in FIG. 3. An error associated with YES regarding whether to provide a QR code requires printer operation to resolve the error. In contrast, an error associated with NO regarding whether to provide a QR code does not require printer operation to resolve the error and is resolved by performing a setting change operation or the like with the RUI.

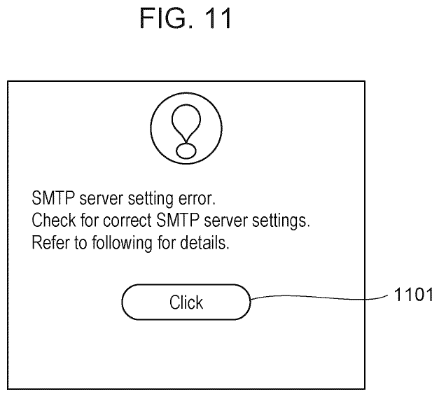

FIG. 11 is a view illustrating an error screen not requiring printer operation to resolve an error according to the present disclosure. The error screen in FIG. 11 has a Click button 1101 thereon. The Click button 1101 has a link to the URL of a user manual stored in the online user manual server 100.

An example of a SMTP server setting error is described. SMTP stands for simple mail transfer protocol. To resolve the SMTP server setting error, the user needs to correctly set values such as a SMTP server name, an account, and a password on the SMTP server setting screen of the RUI.

If a SMTP server setting error occurs while the user is logged in the RUI of the printer 400 by using the web browser of the smartphone 200, the error screen illustrated in FIG. 11 is displayed on the display unit 206. In response to the user pressing the Click button 1101, the user manual describing the measure against the error is displayed on the display unit 206. The user sets values on the SMTP server setting screen of the RUI while looking at the user manual and resolves the error.

As described above, if an error may be resolved with a device displaying the error screen illustrated in FIG. 11 without operating the printer, the error screen including a click button without a QR code is displayed.

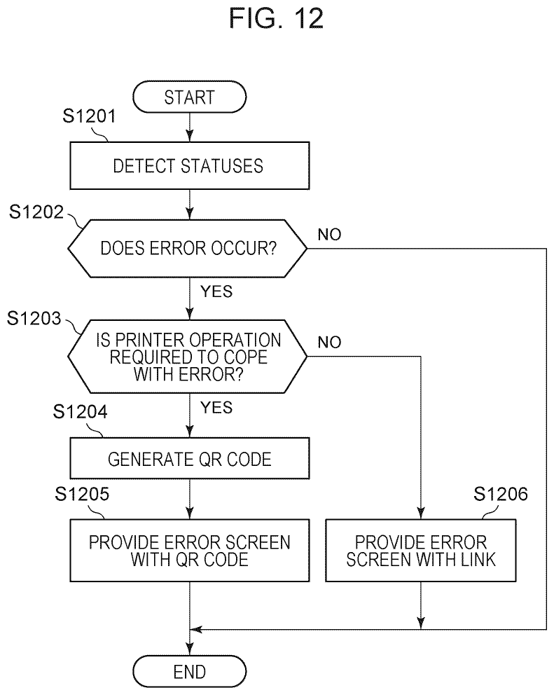

FIG. 12 is a flowchart illustrating error control processing according to the present disclosure. Steps in the flowchart in FIG. 12 are implemented in such a manner that the CPU 401 loads a program stored in the ROM 403 into the RAM 402 and runs the program.

The flowchart is started by the CPU 401 every predetermined cycle when the power of the printer 400 is on. Alternatively, the flowchart is started when the CPU 401 executes a job.

In S1201, the CPU 401 detects the statuses of the printer 400. For example, the CPU 401 acquires the states of the various components of the printer 400, the remaining state of a consumable, the state of a job, and the like and proceeds to S1202.

In S1202, the CPU 401 determines whether there is a status indicating an error in the statuses acquired in S1201. If the CPU 401 determines that there is not a status indicating an error, the CPU 401 terminates this flowchart. If the CPU 401 determines that there is a status indicating an error, the CPU 401 proceeds the processing to S1203.

In S1203, the CPU 401 determines whether to provide a QR code related to the detected error, by referring to the error information list illustrated in FIG. 10 in the ROM 403. If the detected error requires a QR code, the CPU 401 proceeds the processing to S1204. If the detected error does not require a QR code, the CPU 401 proceeds the processing to S1206.

In S1204, the CPU 401 acquires the online user manual URL related to the detected error, by referring to the error information list illustrated in FIG. 3 in the ROM 403. The CPU 401 then generates the QR code based on the URL.

In S1205, the CPU 401 provides the device accessing the RUI with the RUI login error screen with QR code, for example, illustrated in FIG. 5, by using the network I/F 406. The CPU 401 then terminates the flowchart.

If the CPU 401 proceeds the processing from S1203 to S1206, the CPU 401 provides the device accessing the RUI with the SMTP server setting error screen with the link to the URL, for example, illustrated in FIG. 11, by using the network I/F 406. The CPU 401 then terminates the flowchart.

If an error may be resolved with the device having accessed the RUI without operating the printer, the error screen with a link to the user manual URL and without a QR code is provided in this exemplary embodiment. The user may thereby be guided to the manual without being troubled with a QR code. In contrast, if an error is to be resolved by operating the printer, the error screen with a QR code is provided. The user may be guided to display the user manual to the location of the printer with a portable device such as the smartphone.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-138697, filed Aug. 29, 2023, which is hereby incorporated by reference herein in its entirety.

What is claimed is:

1. An image processing apparatus comprising:
an operation unit configured to set authentication information used to operate the image processing apparatus;
a reception unit configured to receive, from an information processing apparatus, a request for a web page provided by the image processing apparatus; and
a transmission unit configured to transmit the web page to the information processing apparatus,
wherein in response to receiving the request, transmitting a web page including code information to the information processing apparatus in accordance with authentication information that satisfies a predetermined condition and that is used for authentication for displaying a web page including information of the image processing apparatus on the information processing apparatus,
wherein, the displayed code information is displayed on a mobile terminal to provide operations required to set the authentication information by the operation unit of the image processing apparatus.

2. The image processing apparatus according to claim 1,
wherein the predetermined condition is that the authentication information used for the authentication for displaying the web page is not set.

3. The image processing apparatus according to claim 1,
wherein the predetermined condition is that the authentication information used for the authentication for displaying the web page is set as an initial value.

4. The image processing apparatus according to claim 1,
wherein the predetermined condition is that the authentication information used for the authentication for displaying the web page has not been changed for a predetermined period.

5. The image processing apparatus according to claim 1,
wherein in response to receiving the request that includes authentication information that satisfies the predetermined condition and that indicates a screen size of a display of the information processing apparatus is smaller than a predetermined size, transmitting, to the information processing apparatus, a web page not including the code information, and
wherein in response to receiving the request that includes authentication information that satisfies the predetermined condition and that indicates the screen size of the display of the information processing apparatus is equal to or greater than a predetermined size, transmitting, to the information processing apparatus, the web page including the code information.

6. The image processing apparatus according to claim 1, further comprising:
a detection unit configured to detect an error,
wherein the transmission unit transmits the web page including the code information to the information processing apparatus in accordance with the error being detected and in accordance with a type of the error being a type requiring operation performed by using the operation unit of the image processing apparatus, and
wherein the transmission unit transmits a web page not including the code information to the information processing apparatus in accordance with the error being detected and in accordance with the type of the error being a type not requiring the operation performed by using the operation unit of the image processing apparatus.

7. The image processing apparatus according to claim 1,
wherein the web page enables changing a setting of the image processing apparatus.

8. The image processing apparatus according to claim 1,
wherein the web page enables changing a setting of the authentication information of the image processing apparatus.

9. The image processing apparatus according to claim 1,
wherein the web page further includes information prompting setting of the authentication information.

10. The image processing apparatus according to claim 1,
wherein the code information is a QR CODE.

11. An image processing apparatus control method comprising:
receiving, from an information processing apparatus, a request for a web page provided by an image processing apparatus; and
transmitting the web page to the information processing apparatus in accordance with receiving the request in the receiving,
wherein in response to the request being received in the receiving, a web page including code information to the information processing apparatus is transmitted in the transmitting in accordance with authentication information satisfying a predetermined condition, the authentication information being used for authentication for displaying a web page including information of the image processing apparatus on the information processing apparatus, the code information being to be captured to display, on a mobile terminal, operation required to set the authentication information by using an operation unit of the image processing apparatus.

12. A non-transitory computer readable storage medium storing a program causing a computer to execute an image processing apparatus control method comprising:
receiving, from an information processing apparatus, a request for a web page provided by an image processing apparatus; and
transmitting the web page to the information processing apparatus in accordance with receiving the request in the receiving,
wherein in response to the request being received in the receiving, a web page including code information to the information processing apparatus is transmitted in the transmitting in accordance with authentication information satisfying a predetermined condition, the authentication information being used for authentication for displaying a web page including information of the image processing apparatus on the information processing apparatus, the code information being to be captured to display, on a mobile terminal, operation required to set the authentication information by using an operation unit of the image processing apparatus.
